(19) United States
(12) Patent Application Publication
(10) Pub. No.: US 2018/0031915 A1
(43) Pub. Date: Feb. 1, 2018

(54) LIQUID CRYSTAL DISPLAY DEVICE AND REFLECTIVE DISPLAY MODULE OF THE SAME

(71) Applicant: Wuhan China Star Optoelectronics Technology Co., Ltd., Wuhan, Hubei (CN)

(72) Inventors: Xinhui ZHONG, Shenzhen, Guangdong (CN); De-jiun LI, Shenzhen, Guangdong (CN)

(73) Assignee: Wuhan China Star Optoelectronics Technology Co., Ltd., Wuhan, Hubei (CN)

(21) Appl. No.: 14/898,831

(22) PCT Filed: Dec. 3, 2015
(86) PCT No.: PCT/CN2015/096263

§ 371 Date: Dec. 16, 2015

(30) Foreign Application Priority Data
Nov. 26, 2015 (CN) 201510845170.4

(51) Int. Cl. G02F 1/1335; G02F 1/1343; G02F 1/1362

(52) U.S. Cl. CPC G02F 1/133553; G02F 1/136209; G02F 1/134336; G02F 1/133514

(57) ABSTRACT

A liquid crystal display device and a reflective display module of the same are disclosed. The reflective display module includes: a first substrate, a reflective layer disposed on the first substrate for reflecting an incident light, and multiple color resists disposed on the reflective layer. Wherein, the incident light enters the reflective layer through the color resist, after the incident light is reflected by the reflective layer, a reflection light is obtained, and the reflection light is emitted out through a same color resist. Through above way, the present invention can avoid the reflection light and the incident light from passing through two different color resists in order to increase reflectivity and eliminating the color mixing.

### BACKGROUND OF THE INVENTION

### 1. Field of the Invention

The present invention relates to a liquid crystal display technology field, and more particularly to a liquid crystal display device and a reflective display module of the same.

### 2. Description of Related Art

With the rising of the wearable device such as the smart watch, the smart glass and so on, the power consumption problem of the display device will affect the endurance capacity of a product, and the endurance time and an interval between charging times will also affect an user experience of a product so that developing a low power consumption and superior performance display device becomes more and more important.

Wherein, the reflective liquid crystal display device has larger potential in the application of the wearable device. Adopting a thin-film transistor active matrix display method has higher image display quality. The reflective liquid crystal display device utilizes a reflective liquid crystal display mode and displays content through reflecting ambient light. No backlight source that consumes a lot of energy is required so as to extend endurance time of a battery of a device and improve the user experience.

In the conventional reflective liquid crystal display device, the upper substrate is a color substrate and the lower substrate is an array substrate. The array substrate provides with a reflective layer, a liquid crystal layer is disposed between the upper substrate and the lower substrate, and the color substrate includes a color resist R, a color resist G and a color resist B. An incident light enters the reflective layer through the color resist. After the incident light is reflected by the reflective layer, a reflection light is generated. The reflection light emits out through the color resist G adjacent to the color resist R. Because an absorption spectra of the color resist R and an absorption spectra of the color resist G are different, after passing through the two different colors resists, the strength of the light is decreased so as to cause the loss of the light.

### SUMMARY OF THE INVENTION

The main technology problem solved by the present invention is to provide a liquid crystal display device and a reflective display module of the same in order to solve the above problems.

In order to solve the above technology problems, a technology solution adopted by the present invention is: a reflective display module, comprising: a first substrate; a reflective layer disposed on the first substrate for reflecting an incident light; multiple color resists disposed on the reflective layer; a second substrate disposed oppositely to the first substrate; an Indium-Tin-Oxide (ITO) electrode layer disposed on a surface of the second substrate closed to the multiple color resists; a liquid crystal layer disposed between the first substrate and the second substrate; and a thin-film transistor disposed between the first substrate and the reflective layer; wherein, the reflective layer is a metal reflective electrode, the incident light enters the reflective layer through the color resist, after the incident light is reflected by the reflective layer, a reflection light is obtained, and the reflection light is emitted out through a same color resist.

Wherein, the display module further includes: a black matrix disposed between two adjacent color resists.

Wherein, the display module further includes: multiple photo spacers disposed above the multiple color resists, wherein, the photo spacer is disposed above the black matrix.

Wherein, the display module further includes: a black matrix disposed on a surface of the second substrate closed to the multiple color resists, and the black matrix is disposed above a location between two adjacent color resists.

Wherein, the display module further includes: multiple photo spacers disposed on the ITO electrode layer, and the photo spacer is disposed above the black matrix.

In order to solve the above technology problems, another technology solution adopted by the present invention is: a reflective display module, comprising: a first substrate; a reflective layer disposed on the first substrate for reflecting an incident light; and multiple color resists disposed on the reflective layer; wherein, the incident light enters the reflective layer through the color resist, after the incident light is reflected by the reflective layer, a reflection light is obtained, and the reflection light is emitted out through a same color resist.

Wherein, the reflective layer is a metal reflective electrode.

Wherein, the display module further includes: a second substrate disposed oppositely to the first substrate; an Indium-Tin-Oxide (ITO) electrode layer disposed on a surface of the second substrate closed to the multiple color resists; and a liquid crystal layer disposed between the first substrate and the second substrate.

Wherein, the display module further includes: a thin-film transistor disposed between the first substrate and the reflective layer.

Wherein, the display module further includes: a black matrix disposed between two adjacent color resists.

Wherein, the display module further includes: multiple photo spacers disposed above the multiple color resists, wherein, the photo spacer is disposed above the black matrix.

Wherein, the display module further includes: a black matrix disposed on a surface of the second substrate closed to the multiple color resists, and the black matrix is disposed above a location between two adjacent color resists.

Wherein, the display module further includes: multiple photo spacers disposed on the ITO electrode layer, and the photo spacer is disposed above the black matrix.

In order to solve above technology problem, another technology solution adopted by the present invention is: a liquid crystal display device, comprising: a first substrate; a reflective layer disposed on the first substrate for reflecting an incident light; multiple color resists disposed on the reflective layer; a second substrate disposed oppositely to the first substrate; an Indium-Tin-Oxide (ITO) electrode layer disposed on a surface of the second substrate closed to the multiple color resists; and a liquid crystal layer disposed between the first substrate and the second substrate; wherein, the incident light enters the reflective layer through the color resist, after the incident light is reflected by the reflective layer, a reflection light is obtained, and the reflection light is emitted out through a same color resist.

Wherein, the reflective layer is a metal reflective electrode.

The beneficial effects of the present invention is: comparing to the conventional art, in the present invention, through disposing the reflective layer on the first substrate for reflecting an incident light, and multiple color resists on the reflective layer. The incident light enters the reflective layer through the color resist, after the incident light is reflected by the reflective layer, a reflection light is obtained, and the reflection light is emitted out through a same color resist. Because the incident light and the reflection light pass through a same color resist, the present invention can avoid the reflection light and the incident light from passing through two different color resists in order to increase reflectivity and eliminating the color mixing.

### BRIEF DESCRIPTION OF THE DRAWINGS

In order to more clearly illustrate the technical solution in the present invention or in the prior art, the following will illustrate the figures used for describing the embodiments or the prior art. It is obvious that the following figures are only some embodiments of the present invention. For the person of ordinary skill in the art without creative effort, it can also obtain other figures according to these figures.

FIG. 1 is a schematic structure diagram of a liquid crystal display device according to a first embodiment of the present invention;

FIG. 2 is an equivalent circuit diagram of the liquid crystal display device shown in FIG. 1; and

FIG. 3 is a schematic structure diagram of a liquid crystal display device according to a second embodiment of the present invention.

### DETAILED DESCRIPTION OF THE PREFERRED EMBODIMENT

The following content combines with the drawings and the embodiment for describing the present invention in detail. It is obvious that the following embodiments are only some embodiments of the present invention. For the person of ordinary skill in the art without creative effort, the other embodiments obtained thereby are still covered by the present invention.

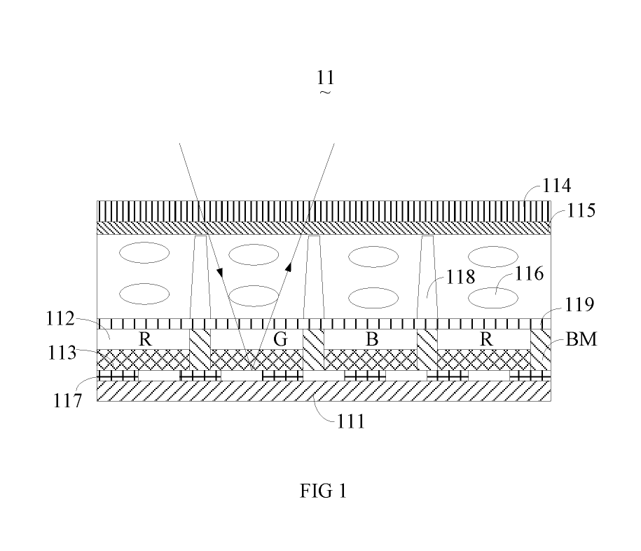

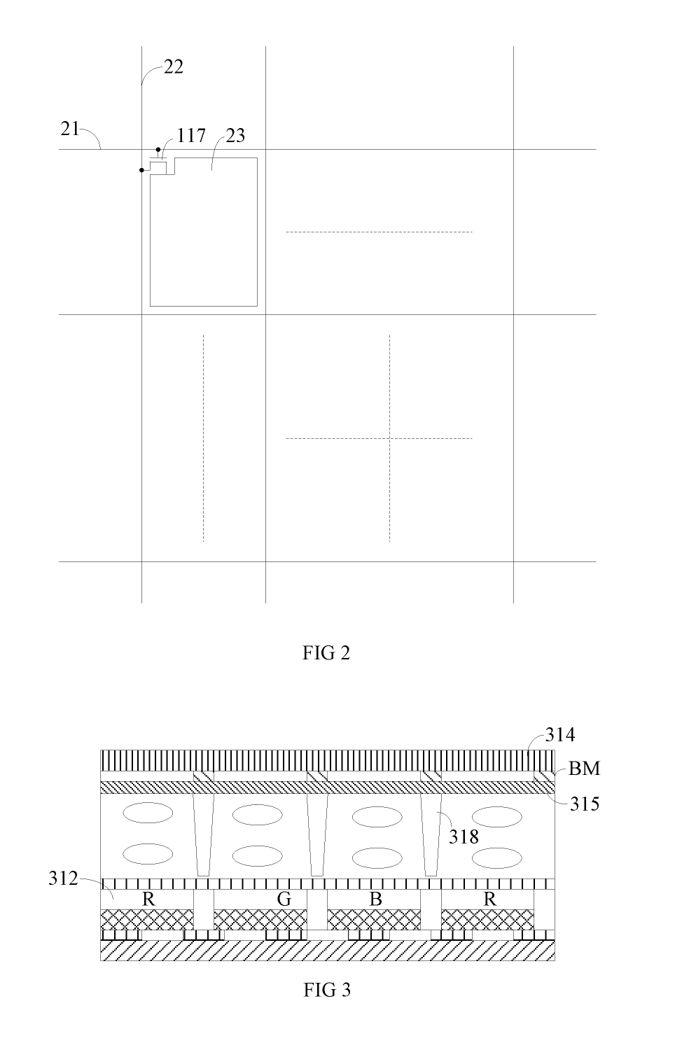

With reference to FIG. 1, FIG. 1 is a schematic structure diagram of a liquid crystal display device according to a first embodiment of the present invention. As shown in FIG. 1, the liquid crystal display device includes a reflective display module 11. Wherein, the display module 11 includes a first substrate 111, multiple color resists 112, a reflective layer 113, a second substrate 114, an ITO electrode layer 115, a liquid crystal layer 116, multiple thin-film transistors (TFT) 117, multiple photo spacers (PS) 118 and a black matrix BM.

Wherein, the first substrate 111 is preferably a glass substrate. The multiple thin-film transistors 117 are disposed on the first substrate 111. As shown in FIG. 2, the liquid crystal display device includes multiple scanning lines 21 and multiple data lines 22, and the multiple scanning lines 21 and the multiple data lines 22 are disposed alternately in order to form multiple pixel units 23. Wherein, each pixel unit 23 includes at least one thin-film transistor 117. A gate electrode of the thin-film transistor 117 is connected with the scanning line 21. A source electrode of the thin-film transistor 117 is connected with the data line 22. A drain electrode of the thin-film transistor 117 is connected with a pixel electrode. Therefore, the multiple scanning lines 21 and the multiple data lines 22 are all disposed on the first substrate 111.

The reflective layer 113 is disposed on the first substrate 111, that is, the reflective layer 113 is disposed on the multiple thin-film transistors 117, multiple scanning lines 21 and the multiple data lines 22. That is, the multiple thin-film transistors 117, multiple scanning lines 21 and the multiple data lines 22 are disposed between the first substrate 111 and the reflective layer 113. The reflective layer 113 is a metal reflective electrode, and a material of the metal reflective electrode is aluminum. In another embodiment, person skilled in the art can utilize an alloy material as the material of the metal reflective electrode such as titanium or aluminum alloy.

Wherein, a surface of the reflective layer 113 closed to the thin-film transistors 117 and a surface of the reflective layer 113 away from the thin-film transistors 117 are both in parallel with the first substrate 111. In another embodiment, person skilled in the art can design the surface of the reflective layer 113 closed to the thin-film transistors 117 and the surface of the reflective layer 113 away from the thin-film transistors 117 to be another shape such as a wavy shape.

The multiple color resists 112 are disposed on the reflective layer 113, the multiple color resists 112 include a color resistor R, a color resist G and a color resist B. Between two adjacent color resists, a black matrix BM is provided. That is, between the color resist R and the color resist G, the black matrix BM is provided, between the color resist G and the color resist B, the black matrix BM is provided, and between the color resist B and the color resist R, the black matrix BM is provided. The black matrix BM is used to prevent a light leakage of the liquid crystal display device in order to increase a display contrast ratio, prevent a color mixing and increase a color saturation.

Optionally, the black matrix BM further divides the reflective layer 113 into multiple reflective blocks corresponding to the multiple color resists 112 one by one in order to avoid a light reflected by the reflective layer 113 and an incident light from passing through different color resists in order to increase reflectivity and eliminating the color mixing.

Optionally, an alignment film 119 is disposed on the multiple color resists 112 and the black matrix BM. The alignment film 119 is used to provide a pre-tilt angle for liquid crystal molecules in the liquid crystal layer 116 such that rotation directions of the liquid crystal molecules are consistent.

Multiple photo spacers 118 are disposed above the multiple color resists 112, wherein, the photo spacer 118 is disposed right above the black matrix BM. The photo spacer 118 is preferably a columnar spacer, which has a high contrast ratio and can reduce a scratch on a color filter substrate because of a spherical spacer under shaking, and the uniformity is good. Wherein, the color filter substrate includes the multiple color resists 112 and the black matrix BM. In another embodiment, the person skilled in the art can also dispose the photo spacer 118 with another shape such as a spherical shape.

The second substrate 114 and the first substrate 111 are disposed oppositely, and the second substrate 114 is preferably a glass substrate. Indium-Tin-Oxide (ITO) electrode layer 115 is disposed on a surface of the second substrate 114 closed to the multiple color resists 112. Wherein, the ITO electrode layer 115 has a high conductivity, a high visible light transmissivity and a high mechanical hardness.

The liquid crystal layer 116 is disposed between the first substrate 111 and the second substrate 114. That is, the liquid crystal layer 116 is disposed between the alignment film 119 and the ITO electrode layer 115.

The following content describes an operation principle of the liquid crystal display device when an ambient light is entered.

When the scanning line 21 provides a scanning signal, the thin-film transistor 117 is turned on, the data line 22 and the pixel electrode are connected, and a voltage of the pixel electrode is changed such that the liquid crystal molecules of the liquid crystal layer 116 corresponding to the pixel electrode are rotated. When an incident light of the ambient light passes through the second substrate 114, the liquid crystal layer 116 and the color resist 112, and enters the reflective layer 113, because the multiple color resists 112 are disposed adjacent to the reflective layer 113 so that a distance between the multiple color resists 113 and the reflective layer 113 becomes smaller. After the incident light is reflected by the reflective layer 113, a reflection light is obtained. The reflection light is emitted out through a same color resist 112. That is, the incident light passes through the color resist R and enters the reflective layer 113, and the reflection light will pass through the same color resist R to emit out. Accordingly, the liquid crystal display device of the present embodiment can avoid the incident light and the reflection light from passing through different color resists in order to increase reflectivity and eliminating the color mixing.

The present invention also provides a second embodiment for the liquid crystal display device. The difference between the second embodiment and the liquid crystal display device disclosed in the first embodiment is: as shown in FIG. 3, the liquid crystal display device disclosed by the present embodiment provides a black matrix BM on a surface of a second substrate 314 closed to multiple color resists 312. Wherein, the black matrix BM is disposed above a location between two adjacent color resists 312. That is, the black matrix BM is disposed right above a location between adjacent color resist R and color resist G, and the black matrix is also disposed right above a location between adjacent color resist G and color resist B.

Multiple photo spacers 318 are disposed on the ITO electrode layer 315. The photo spacer 318 is disposed above the black matrix BM. That is, the photo spacer 318 is disposed corresponding to the black matrix BM. The photo spacer 318 is preferably a columnar spacer, which has a high contrast ratio and can reduce a scratch on the color filter substrate because of a spherical spacer under shaking, and the uniformity is good.

The present invention also provides a display module. The display module is the display module of the liquid crystal display device in the above embodiment.

In summary, in the present invention, through disposing the reflective layer on the first substrate for reflecting an incident light, and multiple color resists on the reflective layer. The incident light enters the reflective layer through the color resist, after the incident light is reflected by the reflective layer, a reflection light is obtained, and the reflection light is emitted out through a same color resist. Because the incident light and the reflection light pass through a same color resist, the present invention can avoid the reflection light and the incident light from passing through two different color resists in order to increase reflectivity and eliminating the color mixing

The above embodiments of the present invention are not used to limit the claims of this invention. Any use of the content in the specification or in the drawings of the present invention which produces equivalent structures or equivalent processes, or directly or indirectly used in other related technical fields is still covered by the claims in the present invention.

What is claimed is:

1. A reflective display module, comprising:
a first substrate;
a reflective layer disposed on the first substrate for reflecting an incident light;
multiple color resists disposed on the reflective layer;
a second substrate disposed oppositely to the first substrate;
an Indium-Tin-Oxide (ITO) electrode layer disposed on a surface of the second substrate closed to the multiple color resists;
a liquid crystal layer disposed between the first substrate and the second substrate; and
a thin-film transistor disposed between the first substrate and the reflective layer;
wherein, the reflective layer is a metal reflective electrode, the incident light enters the reflective layer through the color resist, after the incident light is reflected by the reflective layer, a reflection light is obtained, and the reflection light is emitted out through a same color resist.

2. The display module according to claim 1, wherein, the display module further includes:
a black matrix disposed between two adjacent color resists.

3. The display module according to claim 2, wherein, the display module further includes:
multiple photo spacers disposed above the multiple color resists, wherein, the photo spacer is disposed above the black matrix.

4. The display module according to claim 1, wherein, the display module further includes:
a black matrix disposed on a surface of the second substrate closed to the multiple color resists, and the black matrix is disposed above a location between two adjacent color resists.

5. The display module according to claim 4, wherein, the display module further includes:
multiple photo spacers disposed on the ITO electrode layer, and the photo spacer is disposed above the black matrix.

6. A reflective display module, comprising:
a first substrate;
a reflective layer disposed on the first substrate for reflecting an incident light; and
multiple color resists disposed on the reflective layer;
wherein, the incident light enters the reflective layer through the color resist, after the incident light is reflected by the reflective layer, a reflection light is obtained, and the reflection light is emitted out through a same color resist.

7. The reflective display module according to claim 6, wherein, the reflective layer is a metal reflective electrode.

8. The reflective display module according to claim 6, wherein, the display module further includes:
a second substrate disposed oppositely to the first substrate;
an Indium-Tin-Oxide (ITO) electrode layer disposed on a surface of the second substrate closed to the multiple color resists; and
a liquid crystal layer disposed between the first substrate and the second substrate.

9. The reflective display module according to claim 8, wherein, the display module further includes:
a thin-film transistor disposed between the first substrate and the reflective layer.

10. The reflective display module according to claim 9, wherein, the display module further includes:
a black matrix disposed between two adjacent color resists.

11. The reflective display module according to claim 10, wherein, the display module further includes:
multiple photo spacers disposed above the multiple color resists, wherein, the photo spacer is disposed above the black matrix.

12. The reflective display module according to claim 9, wherein, the display module further includes:
a black matrix disposed on a surface of the second substrate closed to the multiple color resists, and the black matrix is disposed above a location between two adjacent color resists.

13. The reflective display module according to claim 12, wherein, the display module further includes:
multiple photo spacers disposed on the ITO electrode layer, and the photo spacer is disposed above the black matrix.

14. A liquid crystal display device, comprising:
a first substrate;
a reflective layer disposed on the first substrate for reflecting an incident light;
multiple color resists disposed on the reflective layer;
a second substrate disposed oppositely to the first substrate;
an Indium-Tin-Oxide (ITO) electrode layer disposed on a surface of the second substrate closed to the multiple color resists; and
a liquid crystal layer disposed between the first substrate and the second substrate;
wherein, the incident light enters the reflective layer through the color resist, after the incident light is reflected by the reflective layer, a reflection light is obtained, and the reflection light is emitted out through a same color resist.

15. The liquid crystal display device according to claim 14, wherein, the reflective layer is a metal reflective electrode.
